(19) United States
(12) Patent Application Publication
(10) Pub. No.: US 2026/0266972 A1
(43) Pub. Date: Sep. 10, 2026

(54) LIDAR, WINDOW DETECTION DEVICE, AND VEHICLE

(71) Applicant: AUTOX TECH PTE. LTD., SINGAPORE (SG)

(72) Inventors: Zhuo Li, Shenzhen (CN); Yizhou Shan, Shenzhen (CN); Li He, Shenzhen (CN); Gaowen Deng, Shenzhen (CN); Menglei Ji, Shenzhen (CN); Sida Xiao, Shenzhen (CN)

(73) Assignee: AUTOX TECH PTE. LTD., SINGAPORE (SG)

(21) Appl. No.: 19/190,911

(22) Filed: Apr. 28, 2025

(30) Foreign Application Priority Data
Mar. 7, 2025 (CN) 2025102761486

(51) Int. Cl. G01S 7/497; G01S 7/481; G01S 7/487; G01S 17/86; G01S 17/931

(52) U.S. Cl. CPC G01S 7/497; G01S 7/4817; G01S 7/487; G01S 17/86; G01S 2007/4975; G01S 17/931

(57) ABSTRACT

The disclosure provides a window detection device for a LiDAR The LiDAR includes: a rotating part, a transceiver device, a scanning component, and a data processing device. The rotating part is provided with a window, and the transceiver device is mounted on the rotating part and rotates therewith, including a transmitter and a receiver. The transmitter emits a source laser signal of a predetermined wavelength at an emission time; the receiver collects optical signals within the predetermined wavelength range through the window to obtain a signal sequence to be processed. The scanning component is disposed opposite to the window and emits a scanning optical signal of the predetermined wavelength at the emission time. The data processing device filters out signals from the signal sequence to be processed to obtain a sensing signal, and processes the sensing signal to obtain a sensing result.

### CROSS REFERENCE TO RELATED APPLICATION

This non-provisional patent application claims priority under 35 U.S.C. §119 from Chinese Patent Application No. 202510276148.6 filed on Mar. 7, 2025, the entire content of which is incorporated herein by reference.

### TECHNICAL FIELD

The disclosure relates to LiDAR technologies, and in particular, to a LiDAR, a window detection device, and a vehicle.

### BACKGROUND

Currently, the detection of LiDAR windows cannot be carried out in real-time while the LiDAR is operating. Instead, it has to be conducted only after the transceiver device has ceased operation. This is because, if the detection were to occur during operation, the scanning behavior would undermine the performance of the transceiver device. This is because, if the detection were to occur during operation, the scanning behavior will affect the effectiveness of the transceiver device.

A currently used optical scanning solution, special a camera, There are optical limitations, specifically that the window can only allow light of a certain specific wavelength to pass through. The scanning mechanism needs to use the same wavelength as that of the laser transceiver to achieve clear visibility of the window. However, light of the same wavelength will cause mutual interference, so the scanning signal of the window may crosstalk into the LiDAR receiver and be misidentified.

### SUMMARY

The disclosure provides a LiDAR, a window detection device, and a vehicle.

In a first aspect, the disclosure provides a LiDAR, including a rotating part, a transceiver device, a scanning component, and a data processing device. The rotating part is provided with a window; the transceiver device is mounted on the rotating part and rotates therewith, the transceiver device including a transmitter and a receiver, the transmitter being configured to emit a source laser signal of a predetermined wavelength at an emission time, the source laser signal being emitted from the window; the receiver collects optical signals within the predetermined wavelength range through the window to obtain a time-stamped signal sequence to be processed; the scanning component is disposed opposite to the window and emits a scanning optical signal of the predetermined wavelength at the emission time to scan the window; the data processing device includes a signal filtering unit and a data processing unit, the signal filtering unit being configured to filter out signals corresponding to the emission time from the signal sequence to be processed collected by the receiver to obtain a sensing signal; the data processing unit being configured to process the sensing signal to obtain a sensing result.

In a second aspect, the disclosure provides a window detection device applied to a LiDAR, the LiDAR comprising a rotating part, a transceiver device, and a data processing device; the rotating part being provided with a window; the transceiver device being mounted on the rotating part and rotating therewith; the transceiver device including a transmitter and a receiver, the transmitter being configured to emit a source laser signal of a predetermined wavelength at an emission time, the source laser signal being emitted from the window; the receiver collecting optical signals within the predetermined wavelength range through the window to obtain a time-stamped signal sequence to be processed; the data processing device including a signal filtering unit and a data processing unit, the signal filtering unit being configured to filter out signals corresponding to the emission time from the signal sequence to be processed collected by the receiver to obtain a sensing signal; the data processing unit being configured to process the sensing signal to obtain a sensing result; the window detection device including a scanning component, the scanning component being disposed opposite to the window and emitting a scanning optical signal of the predetermined wavelength at the emission time to scan the window.

In a third aspect, the disclosure provides a vehicle comprising the LiDAR and the window detection device according to the above aspects.

The above LiDAR, window detection device, and vehicle scan the LiDAR window through the scanning component to detect the window and return the window status. This determines whether the LiDAR window is dirty, damaged, or obstructed, so that the vehicle can adopt corresponding strategies. The window detection device enables scanning and detection of the window at any time while effectively avoiding interference with LiDAR detecting actions, improving LiDAR efficiency and providing a basis for LiDAR cleaning and vehicle driving dynamics.

### BRIEF DESCRIPTION OF THE DRAWINGS

To more clearly illustrate the technical solutions in the embodiments of the disclosure or the prior art, the drawings to be used in the description of the embodiments or the prior art will be briefly introduced below. It is apparent that the drawings described below are merely some embodiments of the disclosure, and those skilled in the art can obtain other drawings based on the structures shown in these drawings without creative efforts.

FIG. 1 is a schematic diagram of a LiDAR in accordance with an embodiment.

FIG. 2 is a schematic diagram of the overall structure of a LiDAR in accordance with an embodiment.

FIG. 3 is another schematic diagram of a LiDAR in accordance with an embodiment.

FIG. 4 is a signal schematic diagram of a LiDAR in accordance with an embodiment.

FIG. 5 is a schematic diagram of the optical pulse limitation and design of a supplementary light in accordance with an embodiment.

FIG. 6 is a schematic diagram of a vehicle in accordance with an embodiment.

FIG. 7 is another schematic diagram of a vehicle in accordance with an embodiment.

The realization of the objectives, functional features, and advantages of the disclosure will be further described with reference to the embodiments and the drawings.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the present application and are not intended to limit the present application. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the present application are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the present application are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the present application.

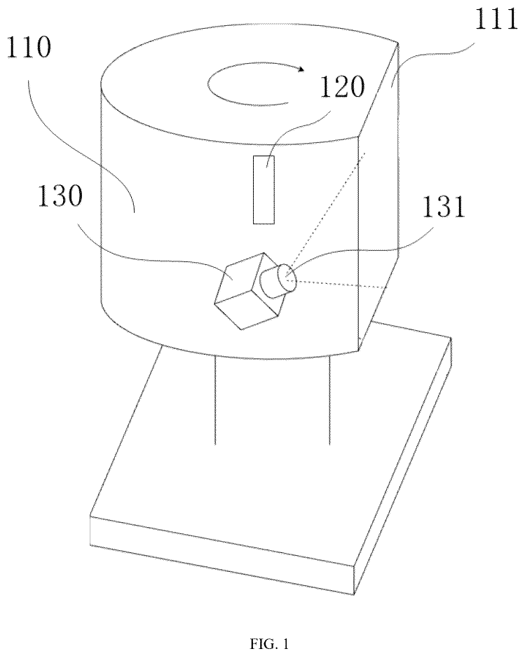

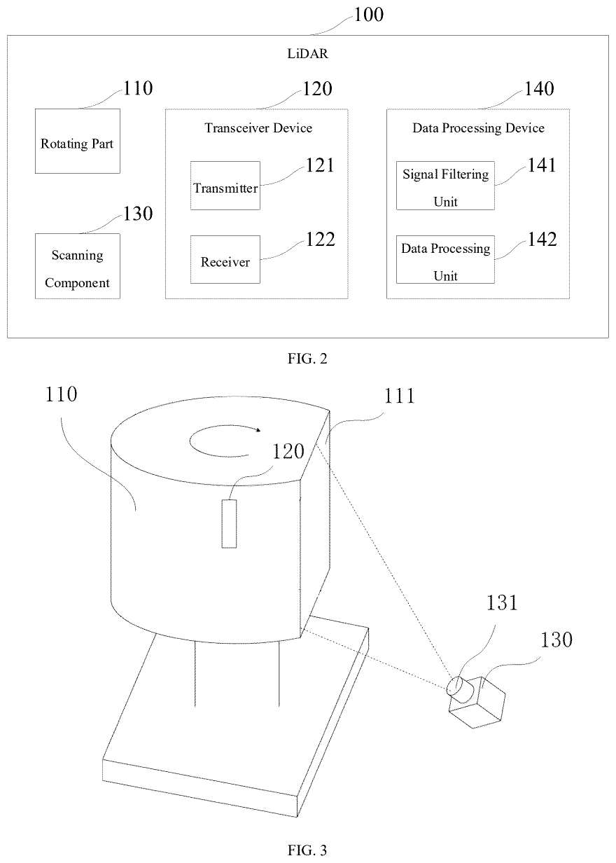

Referring to FIGS. 1 and 2, FIG. 1 is a schematic diagram of a LiDAR in accordance with an embodiment of the disclosure. FIG. 2 is a schematic diagram of the overall structure of a LiDAR in accordance with an embodiment of the disclosure. The LiDAR 100 provided by the embodiment of the disclosure is applied to vehicles, ships, aircraft, robots, etc. The LiDAR 100 includes a rotating part 110, a transceiver device 120, a scanning component 130, and a data processing device 140.

The rotating part 110 has a window 111 for transmitting a laser beam and receiving a returned echo beam. The window 111 is located on an outer surface of the rotating part 110, rotates with the rotating part 110, moving synchronously.

The transceiver device 120 is mounted on the rotating part 110 and rotates with the the rotating part 110. The transceiver device 120 includes a transmitter 121, and a receiver 122. The transmitter 121 is configured to emit a source laser signal of a predetermined wavelength at an emission time, and the source laser signal is emitted from the window 111. The receiver 122 collects optical signals within a predetermined wavelength range through the window 111 to obtain a time-stamped signal sequence to be processed. The predetermined wavelength of the source laser signal emitted by the transmitter 121 of the transceiver device 120, and the laser signal received by the receiver 122 include 905 nm, 940 nm, 1550 nm, and other bands.

The scanning component 130 is disposed opposite to the window 111 and emits a scanning optical signal of the predetermined wavelength at the emission time to scan the window 111.

The scanning component 130 includes a camera 131 configured to emit the scanning optical signal for the purpose of scanning and detecting the window 111. The camera 131 is located on an outer surface of the scanning component 130 and faces the window 111 of the rotating part 110. The camera 131 has a very short exposure time and emits the scanning optical signal of a predetermined wavelength, with the predetermined wavelength of the scanning optical signal including 905 nm, 940 nm, 1550 nm, and other bands.

The scanning component 130 further includes a supplementary light 132 being configured to emit a supplementary light signal. An amplitude and a width of an optical pulse of the supplementary light signal do not exceed that of the laser pulse of the source laser signal.

The data processing device 140 includes a signal filtering unit 141, and a data processing unit 142. The signal filtering unit 141 is configured to filter out signals corresponding to the emission time from the signal sequence to be processed collected by the receiver 122, to obtain a sensing signal. The data processing unit 142 is configured to process the sensing signal to obtain a sensing result.

The LiDAR 100 described above scans the window 111 of the rotating part 110 through the scanning optical signal emitted by the scanning component 130, and uses the data processing device 140 to filter out the signal sequence to be processed to obtain a sensing signal, thereby obtaining the sensing result through the sensing signal. The sensing result represents the current status of the window 111. As a result, the LiDAR 100 can efficiently performs the detection of window 111 to determine the status of the window 111, such that whether it is normal, dirty, damaged, or obstructed.

In this embodiment, the scanning component 130 of the LiDAR 100 can be disposed on the rotating part 110, as shown in FIG. 1, with the scanning component 130 located at a center of a bottom of the rotating part 110. At this time, the camera 131 of the scanning component 130 faces the window 111, and the scanning component 130 and the window 111 are in a relatively stationary state. That is, when the LiDAR 100 is in operation, the rotating part 110 rotates, and the scanning component 130 rotates with the rotating part 110; when the LiDAR 100 is stationary, the rotating part 110 is stationary, and the scanning component 130 is also stationary.

When the scanning component 130 is disposed inside the rotating part 110, the scanning component 130 can scan the window 111 of the LiDAR 100 at any time. During scanning, since the scanning component 130 emits the scanning optical signal of the predetermined wavelength at the emission time, the transmitter 121 also emits the source laser signal of the predetermined wavelength from the window 111 at the emission time. The scanning optical signal emitted by the camera 131 and the source laser signal emitted by the transmitter 121 have the same wavelength, which causes mutual interference as light signals of the same wavelength tend to do so, such that the scanning optical signal emitted by the camera 131 may crosstalk into the receiver 122 of the transceiver device 120 and be misidentified. Therefore, the scanning behavior of the scanning component 130 and the detection behavior of the LiDAR 100 interfere with each other, resulting in reduced detection effectiveness of the LiDAR. At this time, scanning actions of the scanning component 130 on the window 111 needs to cooperate with detecting actions of the transceiver device 120 in a certain way so that they do not interfere with each other.

In this embodiment, the signal sequence to be processed collected by the receiver 122 includes window stray light signals and supplementary light crosstalk signals. The window stray light signals are generated by optical crosstalk and electrical crosstalk inside the LiDAR 100. Since the source laser signal emitted by the transmitter 121 generates reflected light back to the receiver 122 when the source laser signal penetrates the window 111 of the LiDAR 100, the receiver 122 immediately generates a window stray light signal when it receives the reflected light which is generated when the source laser signal penetrates the window 111. The window stray light signal is also generated in the absence of the scanning component 130. To avoid affecting the detection effectiveness of the LiDAR 100, the stray light signal needs to be filtered out during data processing. Since time for the reflected light to return to the receiver 122 is very close to the emission time of the laser source signal emitted by the transmitter 121, the window stray light signal can be filtered out by the signal filtering unit 141 in the data processing device 140 of the LiDAR 100 based on the time for the reflected light to return to the receiver 122.

Therefore, the scanning optical signal generated by the camera 131 of the scanning component 130 overlaps with the window stray light signal generated by the receiver 122 itself, such that both the scanning optical signal and the window stray light signal are filtered out, achieving the effect of non-interference between the transceiver device 120 and the scanning component 130. Therefore, if the scanning optical signal generated by the camera 131 for window 111 detection is to be eliminated, the scanning optical signal needs to be controlled to the same time as the window stray light signal, so that they are filtered out together by the signal filtering unit 141 in the data processing device 140 of the LiDAR 100. At this time, the data processing device 140 of the LiDAR 100 processes the sensing signal obtained after filtering out the interference signal from the receiver 122 to obtain the final sensing result.

In this embodiment, the scanning component 130 of the LiDAR 100 can also be disposed outside the rotating part 110, as shown in FIG. 3, with the scanning component 130 located at a lower position outside the rotating part 110. The scanning component 130 is fixed at a position a certain distance away from the rotating part 110. When the rotating part 110 rotates to a specific position, the camera 131 of the scanning component 130 can face the window 111 and scan and detect the window 111. When the scanning component 130 is disposed outside the rotating part 110, the scanning methods for the window 111 of the LiDAR 100 in operation and the window 111 of the LiDAR 100 not in operation are different.

When the LiDAR 110 is not in operation, the rotating part 110 is stationary. The window 111 of the rotating part 110 is turned to the scannable area of the camera 131 of the scanning component 130 for scanning and detection.

When the LiDAR 100 is in operation, the rotating part 110 is rotating. Since the scanning component 130 is fixed in a fixed position, there is relative motion between the scanning component 130 and the window 111. At this time, the scanning component 130 needs to complete scanning and detection when the window 111 of the rotating part 110 rotates to the scannable area of the scanning component 130. The scanning speed of the scanning component 130 is related to the rotation speed of the rotating part 110, the scanning area coverage, and the size of the window 111.

In this embodiment, when the LiDAR 100 is in a daytime environment with sufficient ambient light, the camera 131 directly performs passive scanning on the window 111 without the need for a fill light device to illuminate the camera. When the LiDAR 100 is in a nighttime environment without sufficient ambient light, a supplementary light 132 must cooperate with the camera 131 to provide sufficient lighting conditions for the scanning work of the camera 131. However, the illumination of the supplementary light 132 may also cause signal interference with the LiDAR 100 to a certain extent.

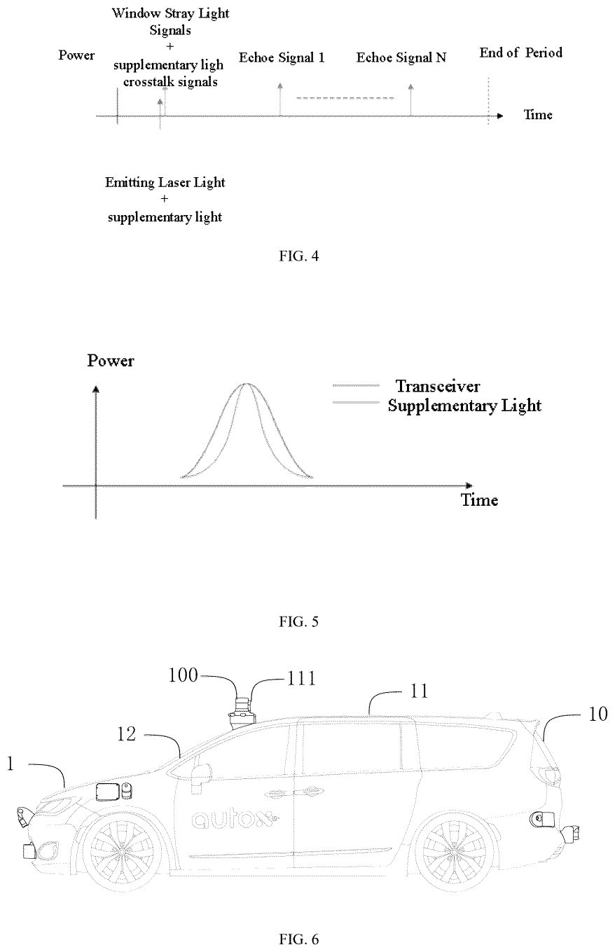

Referring to FIGS. 4 and 5, FIG. 4 is a signal schematic diagram of a LiDAR in accordance with an embodiment of the disclosure. FIG. 5 is a schematic diagram of the optical pulse limitation and design of a supplementary light in accordance with an embodiment of the disclosure.

In this embodiment, the supplementary light 132 is integrated into the scanning component 130 and projects onto the window 111. The supplementary light crosstalk signal generated by the supplementary light 132 of the scanning component 130 overlaps with the window stray light signal generated by the receiver 122 itself, such that both the supplementary light crosstalk signal and the window stray light signal are filtered out, achieving the non-interference effect between the LiDAR 100 and the scanning component 130. Therefore, if the supplementary light crosstalk signal caused by the supplementary light 132 for window 111 detection is to be eliminated, the supplementary light crosstalk signal needs to be controlled to the same time as the window stray light signal. Therefore, the LiDAR transmitter 121 and the supplementary light 132 need to be turned on at the same time, and the continuous lighting period must be the same length of time. Furthermore, the fill light pulse needs to be limited such that the fill light pulse has no impact on the detection of the LiDAR 100. The optical pulse of the supplementary light 132 is controlled to have a height and width not exceeding those of the laser pulse of the LiDAR transmitter 121.

In some feasible embodiments, the supplementary light 132 may also be disposed in the rotating part 110 to provide fill light for the scanning device.

In this embodiment, the scanning of the window 111 by the scanning component 130 can be in any form. The scanning component 130 can at least scan and return the status of the window 111 of the LiDAR 100 in the form of electromagnetic waves and mechanical waves, such as normal, dirty, damaged, or obstructed. Electromagnetic waves are light of different wavelengths, including visible light, invisible light, radio waves, and microwaves, etc. Mechanical waves include sound waves, transverse mechanical waves of surface vibrations of objects, etc. The present embodiment currently uses an optical scanning method, but other scanning methods may also be used to scan the window 111.

The LiDAR 100 completes real-time scanning of the LiDAR window 111 without affecting the effectiveness of the transceiver device 120 by placing the scanning component 130 in different positions. Furthermore, the duration of the transceiver device 120 transmitting and receiving its own signal is extremely short. In the operating state of the LiDAR, the scanning component 130 cooperates with the rotating part 110 to complete scanning and detection of the window 111 in a very short time.

An embodiment of the disclosure further provides a window detection device 200. The window detection device 200 is applied to the LiDAR 100. The LiDAR 100 includes a rotating part 110, a transceiver device 120, and a data processing device 140. The rotating part 110 has a window 111. The transceiver device 120 is mounted on the rotating part 110 and rotates relatively with the rotating part 110. The transceiver device 120 includes a transmitter 121 and a receiver 122. The transmitter 121 is configured to emit a source laser signal of a predetermined wavelength at an emission time, the source laser signal is emitted from the window 111. The receiver 122 collects optical signals within the predetermined wavelength range through the window 111 to obtain a time-stamped signal sequence to be processed. The data processing device 140 includes a signal filtering unit 141 and a data processing unit 142, the signal filtering unit 141 being configured to filter out signals corresponding to the emission time from the signal sequence to be processed collected by the receiver 122 to obtain a sensing signal; the data processing unit 142 being configured to process the sensing signal to obtain a sensing result. The window detection device 200 includes a scanning component 130, which is disposed opposite to the window 111 and emits a scanning optical signal of the predetermined wavelength at the emission time to scan the window 111.

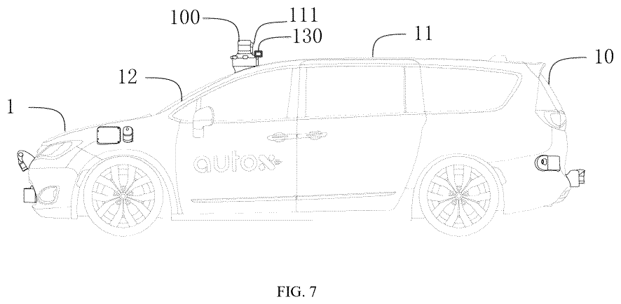

Referring to FIGS. 6 and 7, FIG. 6 is a schematic diagram of a vehicle in accordance with an embodiment of the disclosure. FIG. 7 is another schematic diagram of a vehicle in accordance with an embodiment of the disclosure. The embodiment of the disclosure further provides a vehicle 1, including a vehicle body 10 and a LiDAR 100 disposed on the vehicle body 10. The LiDAR 100 can be mounted on the top (roof) 11 and a side 12 of the vehicle body 10 of the vehicle 1. Specifically, the window detection device 100 can be mounted on the front and rear bumpers, roof, headlights, front cover, and other sides of the vehicle 1.

The above LiDAR 100, window detection device 200, and vehicle 1 scan the window 111 of the LiDAR 100 through the scanning component 130 to detect the window 111 and return the status of the window 111. This determines whether the LiDAR window 111 is dirty, damaged, or obstructed, so that the autonomous vehicle can adopt corresponding strategies. The window detection device 200 enables scanning and detection of the window 111 at any time while effectively avoiding interference with the detecting actions of the LiDAR 100, improving the efficiency of the LiDAR 100 and providing a basis for LiDAR cleaning and autonomous driving dynamics.

It is apparent to those skilled in the art that various modifications and variations can be made to the disclosure without departing from the spirit and scope thereof. Therefore, if these modifications and variations of the disclosure fall within the scope of the claims and their equivalent technologies, the disclosure also intends to include these modifications and variations.

The foregoing list is merely preferred embodiments of the disclosure and cannot be used to limit the scope of the claims of the disclosure. Therefore, equivalent changes made in accordance with the claims of the disclosure still fall within the scope covered by the disclosure.

1. A LiDAR, comprising:
a rotating part, provided with a window;
a transceiver device, mounted on the rotating part and rotating with the rotating part, the transceiver device comprising a transmitter, and a receiver; the transmitter being configured to emit a source laser signal of a predetermined wavelength at an emission time, the source laser signal being emitted from the window; the receiver collecting optical signals within the predetermined wavelength range through the window to obtain a signal sequence to be processed having a time-stamp;
a scanning component, disposed opposite to the window, the scanning component emitting a scanning optical signal of the predetermined wavelength at the emission time to scan the window; and
a data processing device, comprising:
a signal filtering unit, configured to filter out signals corresponding to the emission time from the signal sequence to be processed collected by the receiver to obtain a sensing signal; and
a data processing unit, configured to process the sensing signal to obtain a sensing result.

2. The LiDAR according to claim 1, wherein the scanning component is disposed on the rotating part.

3. The LiDAR according to claim 1, wherein the scanning component is disposed outside the rotating part.

4. The LiDAR according to claim 2, wherein the scanning component is disposed opposite to the window and rotates synchronously with the rotating part, such that the scanning optical signal covers the window.

5. The LiDAR according to claim 1, wherein the scanning component comprises a camera, the camera emitting the scanning optical signal.

6. The LiDAR according to claim 1, wherein the scanning component further comprises a supplementary light emitting a supplementary light signal.

7. The LiDAR according to claim 6, wherein amplitude and width of the optical pulse of the supplementary light signal do not exceed that of laser pulses of the source laser signal.

8. The LiDAR according to claim 6, wherein the supplementary light is integrated into the scanning component and projects onto the window.

9. A window detection device for a LiDAR, comprising a rotating part, a transceiver device, and a data processing device; the rotating part being provided with a window; the transceiver device being mounted on the rotating part and rotating therewith; the transceiver device comprising a transmitter and a receiver, the transmitter being configured to emit a source laser signal of a predetermined wavelength at an emission time, the source laser signal being emitted from the window; the receiver collecting optical signals within the predetermined wavelength range through the window to obtain a time-stamped signal sequence to be processed; the data processing device comprising a signal filtering unit and a data processing unit, the signal filtering unit being configured to filter out signals corresponding to the emission time from the signal sequence to be processed collected by the receiver to obtain a sensing signal; the data processing unit being configured to process the sensing signal to obtain a sensing result; wherein the window detection device comprises a scanning component being disposed opposite to the window, the scanning component emitting a scanning optical signal of the predetermined wavelength at the emission time to scan the window.

10. The window detection device according to claim 9, wherein the scanning component is disposed on the rotating part.

11. The window detection device according to claim 9, wherein the scanning component is disposed outside the rotating part, the scanning component is disposed opposite to the window and rotates synchronously with the rotating part, such that the scanning optical signal covers the window.

12. The LiDAR according to claim 1, wherein the scanning component comprises a camera, the camera emitting the scanning optical signal.

13. The window detection device according to claim 9, wherein the scanning component further comprises a supplementary light emitting a supplementary light signal.

14. The window detection device according to claim 13, wherein amplitude and width of the optical pulse of the supplementary light signal do not exceed that of laser pulses of the source laser signal.

15. The window detection device according to claim 9, wherein the supplementary light is integrated into the scanning component and projects onto the window.

16. A vehicle, comprising a LiDAR, wherein the LiDAR comprises:
a rotating part, provided with a window;
a transceiver device, mounted on the rotating part and rotating with the rotating part, the transceiver device comprising a transmitter, and a receiver; the transmitter being configured to emit a source laser signal of a predetermined wavelength at an emission time, the source laser signal being emitted from the window; the receiver collecting optical signals within the predetermined wavelength range through the window to obtain a signal sequence to be processed having a time-stamp;
a window detection device, comprising scanning component being disposed opposite to the window, the scanning component emitting a scanning optical signal of the predetermined wavelength at the emission time to scan the window; and
a data processing device, comprising:
a signal filtering unit, configured to filter out signals corresponding to the emission time from the signal sequence to be processed collected by the receiver to obtain a sensing signal; and
a data processing unit, configured to process the sensing signal to obtain a sensing result.

17. The vehicle according to claim 16, wherein the scanning component is disposed on the rotating part.

18. The vehicle according to claim 16, wherein the scanning component further comprises a supplementary light emitting a supplementary light signal.

19. The vehicle according to claim 18, wherein amplitude and width of the optical pulse of the supplementary light signal do not exceed that of laser pulses of the source laser signal.

20. The vehicle according to claim 16, wherein the supplementary light is integrated into the scanning component and projects onto the window.
